(19) United States
(12) Patent Application Publication
(10) Pub. No.: US 2011/0310014 A1
(43) Pub. Date: Dec. 22, 2011

(54) IMAGE PICKUP APPARATUS AND PROJECTION TYPE IMAGE DISPLAY APPARATUS

(75) Inventors: Fuminori MIZUNO, Moriguchi City (JP); Kazuo Ishimoto, Moriguchi City (JP); Toru Watanabe, Moriguchi City (JP)

(73) Assignee: SANYO Electric Co., Ltd., Moriguchi City (JP)

(21) Appl. No.: 13/165,082

(22) Filed: Jun. 21, 2011

(30) Foreign Application Priority Data
Jun. 21, 2010 (JP) 2010-140661
Oct. 19, 2010 (JP) 2010-234760

(51) Int. Cl. G09G 5/00; H04N 9/04

(52) U.S. Cl. 345/158; 348/273; 348/280; 348/E09.002

(57) ABSTRACT

In an image pickup apparatus, a visible light cut filter allows infrared components to pass through, and blocks visible light components. A plurality of image pickup devices receive the light transmitted through the visible light cut filter such that a plurality of color components are received separately from each other. The visible light cut filter allows part of the visible light components to transmit such that the visible light component enters at least one of the plurality of image pickup devices.

This application is based upon and claims the benefit of priority from the prior Japanese Patent Applications No.2010-140661, filed on Jun. 21, 2010 and Japanese Patent Application No. 2010-234760, filed on Oct. 19, 2010, the entire contents of which are incorporated herein by reference.

### BACKGROUND OF THE INVENTION

1. Field of the Invention

The present invention relates to an image pickup apparatus for capturing the image of a projection plane and a projection type image display apparatus carrying said image pickup apparatus.

2. Description of the Related Art

Recent years have seen a broadening practical use of a projection type image display apparatus carrying a camera (hereinafter referred to as “projector” as appropriate). The camera mounted thereon can be used for start-up settings such as trapezoidal distortion correction and autofocus adjustment. That is, the camera takes an image of a test pattern projected on a screen at the initial setting, and the projector itself carries out trapezoidal distortion correction and autofocus adjustment using the image picked up by the camera.

Also, as a recent trend, presentation or study guidance using the projector employs systems of directly writing letters or drawing diagrams on the screen by the use of a pointing device (e.g., a pointing pen using a laser). Such a system often uses infrared rays, instead of visible light, cast from the pointing device in order to minimize the effects of extraneous lights or accidental application of laser light on human eyes.

The above-mentioned test pattern at initial setting is normally projected with visible light. Accordingly, the camera to capture the test pattern is generally one equipped with an infrared cut filter. On the other hand, the camera to detect the coordinate position cast by the pointing device using infrared rays is generally an infrared camera equipped with a visible light cut filter. As a result, a projector carrying both of the systems must be equipped with two cameras.

### SUMMARY OF THE INVENTION

An image pickup apparatus according to one embodiment of the present invention includes: a visible light cut filter configured to transmit an infrared component and configured to block-a visible light component; and a plurality of image pickup devices configured to receive light transmitted through the visible light cut filter such that a plurality of color components are received separately from each other. The visible light cut filter allows part of the visible light components to transmit such that the visible light component enters at least one of the plurality of image pickup devices.

Another embodiment of the present invention relates also to an image pickup apparatus. This apparatus includes a visible light cut filter configured to transmit an infrared component and configured to block a visible light component; and a plurality of image pickup devices configured to receive light transmitted through the visible light cut filter such that a plurality of color components are received separately from each other. The visible light cut filter is set such that the transmittance of visible light wavelength region is set to a value which is greater than zero and which is less than the transmittance of near-infrared wavelength region.

Still another embodiment of the present invention relates to a projection type image display apparatus. This apparatus includes: a projection unit configured to project an image onto a projection plane; and the above-described image pickup apparatus configured to pick up an image of the projection plane. The image pickup apparatus is used to both pick up a pattern image in start-up setting of the projection type image display apparatus and pick up a pointing image projected onto the projection plane by a pointing device emitting infrared rays.

Still another embodiment of the present invention relates to a projection type image display apparatus. This apparatus includes: a projection unit configured to project an image onto a projection plane; an image pickup apparatus configured to pick up an image of the projection unit; and an image analysis unit configured to identify pointing coordinates specified by a red component signal as the pointing coordinates projected onto the projection plane by a pointing device emitting red light, configured to identify pointing coordinates specified by a green component signal as the pointing coordinates projected onto the projection plane by a pointing device emitting green light and configured to identify pointing coordinates specified by a near-infrared component signal as the pointing coordinates projected onto the projection plane by a pointing device emitting infrared rays.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 is a diagram for explaining a structure of a projection type image display apparatus according to a first embodiment of the present invention, a projection plane, and a pointing device;

FIGS. 2A and 2B are diagrams showing the roles of the respective image pickup, devices in a Bayer arrangement according to a first embodiment of the present invention;

FIG. 3 is a graph showing a characteristic Fcv of a visible light cut filter, a characteristic Fr of a red transmission filter, a characteristic Fg of a green transmission filter, and a characteristic Fb of a blue transmission filter of a first embodiment;

FIGS. 4A and 4B are graphs showing the roles of the respective image pickup devices in a Bayer arrangement according to a second embodiment of the present invention;

FIG. 5 is a graph showing a characteristic Fcv of a visible light cut filter, a characteristic Fr of a red transmission filter, a characteristic Fg of a green transmission filter, and a characteristic Fb of a blue transmission filter of a second embodiment;

FIG. 6 is a graph showing a characteristic Fcv of a visible light cut filter, a characteristic Fr of a red transmission filter, a characteristic Fg of a green transmission filter, and a characteristic Fb of a blue transmission filter of a third embodiment;

FIG. 7 is a diagram showing an exemplary structure of an image analysis unit according to a fourth embodiment;

FIG. 8 is a diagram showing a structure of an image pickup apparatus according to a fifth embodiment;

FIG. 9 is a graph showing a characteristic Fcgb of a GB cut filter as well as a characteristic Fr of a red transmission filter, a characteristic Fg of a green transmission filter, and a characteristic Fb of a blue transmission filter before the installation of the GB cut filter, according to a fifth embodiment;

FIG. 10 is a graph showing a characteristic Fcgb of a GB cut filter as well as a characteristic Fr of a red transmission filter, a characteristic Fg of the green transmission filter, and a characteristic Fb of a blue transmission filter after the installation of the GB cut filter, according to a fifth embodiment;

FIG. 11 is a graph showing a characteristic Fcgb of a GB cut filter as well as a characteristic Fr of a red transmission filter, a characteristic Fg of a green transmission filter, and a characteristic Fb of a blue transmission filter after the installation of the GB cut filter and the addition of a pseudo correction, according to a fifth embodiment;

FIG. 12 is a diagram showing a structure of an image pickup apparatus according to a sixth embodiment; and

FIG. 13 is a graph showing a characteristic Fcb of a B cut filter as well as a characteristic Fr of a red transmission filter, a characteristic Fg of a green transmission filter, and a characteristic Fir of a blue transmission filter after the installation of the B cut filter, according to a sixth embodiment.

### DETAILED DESCRIPTION OF THE INVENTION

The invention will now be described by reference to the preferred embodiments. This does not intend to limit the scope of the present invention, but to exemplify the invention.

### First Embodiment

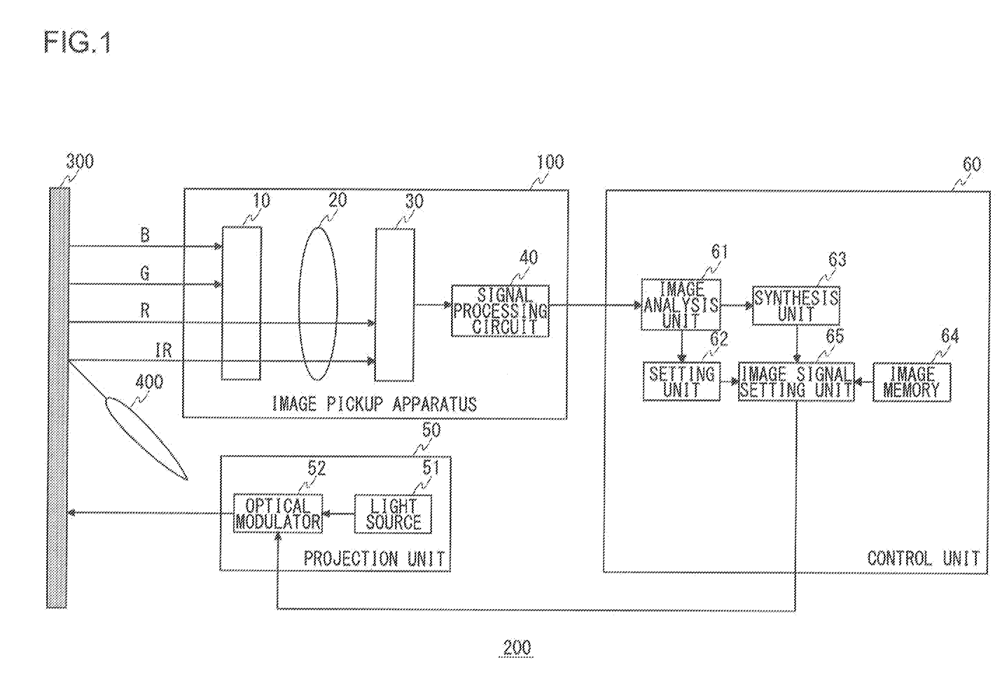

FIG. 1 is a diagram for explaining a structure of a projection type image display apparatus 200 according to a first embodiment of the present invention, a projection plane 300, and a pointing device 400. The projection type image display apparatus 200 includes a projection unit 50, an image pickup apparatus 100, and a control unit 60.

The projection unit 50 projects an image onto the projection plane 300 such as a screen. The projection unit 50 includes a light source 51 and an optical modulator 52. The type of the light source 51 that can be employed includes a halogen lamp having a filament-type electrode structure, a metal halide lamp having an electrode structure capable of producing arc discharge, a xenon short arc lamp, a high-pressure mercury lamp, and an LED lamp.

The optical modulator 52 modulates the light incident from the light source 51 according to an image signal set by the control unit 60 (more precisely by an image signal setting unit 65 to be discussed later). For example, a digital micromirror device (DMD) can be employed as the optical modulator 52. The DMD, which is equipped with a plurality of micromirrors corresponding to the number of pixels, can produce desired image light as the orientation of each micromirror is controlled according to each pixel signal.

The image pickup apparatus 100 is installed in a fixed manner at a predetermined position on a casing of the projection type image display apparatus 200 or at a predetermined position away from the casing thereof in order to capture the image of the projection plane 300. The image pickup apparatus 100 includes a visible light cut filter 10, a lens 20, image pickup devices 30, and a signal processing circuit 40.

The visible light cut filter 10 transmits the infrared components of light reflected from the projection plane 300 and blocks basically the visible-light components of light reflected from the projection plane 300. A plurality of image pickup devices 30 receive via the lens 20 the light passed through the visible light cut filter 10 such that a plurality of color components are received separately from each other.

The image pickup devices 30 that can be used are CMOS (Complementary Metal Oxide Semiconductor) image sensors or CCD (Charge-Coupled Devices) image sensors, for instance. The plurality of image pickup devices 30 are arranged in a matrix, and a color filter is provided for each of the image pickup devices 30. Hereinbelow in this specification, a description will be given of an example in which the incident light to the image pickup devices 30 is received by decomposing it by the use of an RGB primary color filter (red transmission filter, green transmission filter, and blue transmission filter) into a red component, a green component, and a blue component thereof.

The incident light may be decomposed by the use of a complementary filter into yellow, cyan, and magenta components or the yellow, cyan, and green components or yellow, cyan, magenta, and green components.

When the RGB primary color filter is to be installed, the plurality of image pickup devices 30, which include those to receive the red component (hereinafter referred to as “red image pickup device), those to receive the green component (hereinafter referred to as “green image pickup device), and those to receive the blue component (hereinafter referred to as “blue image pickup device), are configured in a Bayer arrangement.

The visible light cut filter 10 allows part of the visible light components to pass through such that the visible light component enters at least one of the plurality of image pickup devices 30. In the first embodiment, at least part of the red component is transmitted, so that at least the part of the red component enters the red image pickup device.

The signal processing circuit 40 performs various signal processings, such as analog-to-digital (A/D) conversion and RGB format to YUV format conversion, on the signals outputted from the image pickup devices 30, thereby outputting the processed signals to the control unit 60.

The image pickup apparatus 100 is used for both of the capturing of a pattern image in start-up setting of the projection type image display apparatus 200 and the capturing of a pointing image projected onto the projection plane 300 by the pointing device 400 sending infrared rays. Note also that the image pickup apparatus 100 is used for capturing images in a calibration processing for the pointing device 400. These processings will be described in detail later.

The pointing device 400, which is provided with an infrared LED, for instance, is a device capable of emitting infrared rays. Also, the pointing device 400 may be provided with a visible-light LED, such as a red LED, so that it can give off a visible light. This function of emitting a visible light can be utilized in calibration.

The control unit 60 performs an overall control of the projection type image display apparatus 200. The control unit 60 includes an image analysis unit 61, a setting unit 62, a synthesis unit 63, an image memory 64, and an image signal setting unit 65.

The structure of the control unit 60 may be achieved hardwarewise by elements such as a given processor, memory and other LSIs, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

The image memory 64 stores image signals to be projected onto the projection plane 300. The image memory 64 also stores test pattern images to be used in setting the projection type image display apparatus 200 (e.g., pattern image for detection of trapezoidal distortion, pattern image for focus adjustment). Such test pattern images may be stripe pattern, checkered flag pattern, and so forth. Also, the image memory 64 stores test pattern images for calibration of the pointing device 400. Such a test pattern image may be a pattern with a plurality of points spaced apart from each other at arbitrary intervals, for instance.

The image signal setting unit 65 sets each of the required test pattern images for the setting of the projection type image display apparatus 200 in the optical modulator 52, thereby projecting it onto the projection plane 300. The image pickup apparatus 100 captures the test pattern image projected onto the projection plane 300. As already described, although the image pickup apparatus 100 is provided with the visible light cut filter 10, the test pattern image can be captured because part of the visible light components (red component in the first embodiment) is allowed to transmit the visible light cut filter 10.

It is to be noted that the settings of the projection type image display apparatus 200 basically concern the positional relationship between the projection type image display apparatus 200 and the projection plane 300 and/or focusing, and therefore there is no need to use a test pattern image having color variations. Hence, the receiving of the red component only can achieve recognition of the test pattern without any problem.

The image analysis unit 61 analyzes the test pattern image captured by the image pickup apparatus 100 and supplies the results of the analysis to the setting unit 62. In the trapezoidal distortion correction, the setting unit 62 sets in the image signal setting unit 65 a correction value for correcting the image signal in response to the identified vertical or horizontal swell in the test pattern image in such a manner as to cancel out the swell. In the focus adjustment, the setting unit 62 sets the position of the focusing lens (not shown) to an optimum position using contrast detecting technique.

The image signal setting unit 65 sets a test pattern image required for the calibration of the pointing device 400 in the optical modulator 52, thereby projecting the test pattern image onto the projection plane 300. A user of the pointing device 400 directs a visible light (red light in the first embodiment) at a point within the test pattern image.

The image analysis unit 61 analyzes the positional relationship between the test pattern image captured by the image pickup apparatus 100 and the pointing image cast by the pointing device 400, which is tapped by the user, and supplies the results of the analysis to the setting unit 62. If there is any positional mismatch, the setting unit 62 sets in the image signal setting unit 65 a correction value for correcting the coordinate values in such a manner as to effect the calibration for the positional mismatch.

During normal projection, the synthesis unit 63 identifies the coordinate values pointed by the pointing device 400 and makes the setting in the image signal setting unit 65 so that predetermined color data is rendered at the coordinate values. Note that although the image pickup apparatus 100 does not include image pickup devices for detecting infrared rays, the infrared rays emitted by the pointing device 400 can be captured because the ordinary color filter passes infrared rays.

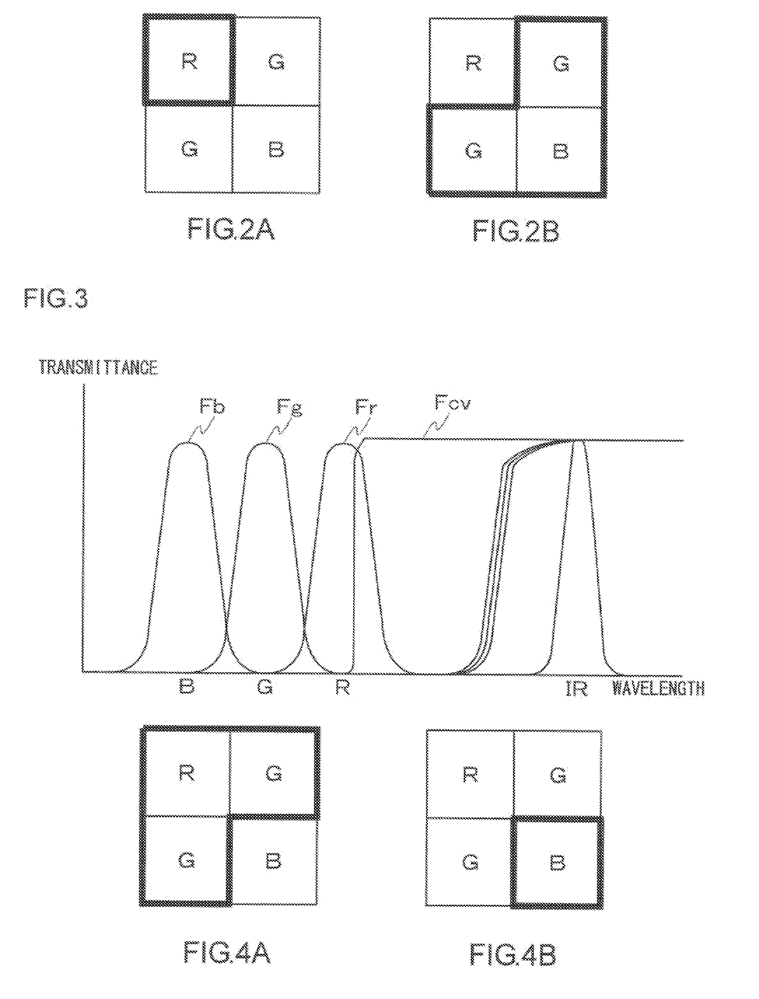

FIGS. 2A and 2B are diagrams showing the roles of the respective image pickup devices in a Bayer arrangement according to the first embodiment of the present invention. FIG. 3 is a diagram showing the characteristic Fcv of the visible light cut filter 10, the characteristic Fr of the red transmission filter, the characteristic Fg of the green transmission filter, and the characteristic Fb of the blue transmission filter of the first embodiment. As shown in FIG. 3, the visible light cut filter 10 has a cutoff wavelength in a red wavelength region.

Therefore, for the setting of the projection type image display apparatus 200 and for the calibration of the pointing device 400, the red image pickup device is used as shown in FIG. 2A. This is because the red image pickup device can detect the red component of the visible light components.

On the other hand, for the pointing during normal projection, the green and blue image pickup devices are used as shown in FIG. 2B. The red transmission filter, the green transmission filter, and the blue transmission filter transmit near-infrared light and also the infrared components of light emitted by the pointing device 400. Yet, by not using the red image pickup device which also receives the other visible light (red component herein), the infrared ray illumination by the pointing device 400 can be recognized with accuracy.

According to the first embodiment as described above, provision of a visible light cut filter can accomplish the start-up settings of the projector and the drawing system using the pointing device with a single camera. Also, if a pointing device capable of emitting visible light is used, then the calibration thereof can be realized by the same camera. Furthermore, ordinary solid-state image sensing devices configured in a Bayer arrangement may be employed without use of the image pickup devices for infrared rays.

Also, according to the first embodiment, the visible light cut filter provided on the image sensor equipped with the RGB primary color filter allows structuring at low cost of an image sensor capable of separately acquiring visible light signals and infrared light signals. The image sensor having regularly arranged color filter for transmitting visible-light components and color filter for transmitting infrared-light components has only limited uses, so that the image sensor may not be mass-produced and thus may tend to be expensive. Contrary to this, the image sensor equipped with the RGB primary color filter has its applications in digital still cameras, mobile phones and the like, so that the image sensor is mass-produced and less expensive. Thus, the present embodiment employing a less expensive image sensor enables production of the projection type image display apparatus 200 at low cost.

### Second Embodiment

A description is now given of a second embodiment. The second embodiment is an example where the cutoff wavelength of the visible cut filter 10 is set at a shorter-wavelength side. The structures and operations of an image pickup apparatus 100 and a projection type image display apparatus 200 according to the second embodiment are basically the same as those of the first embodiment and therefore the description thereof is omitted here.

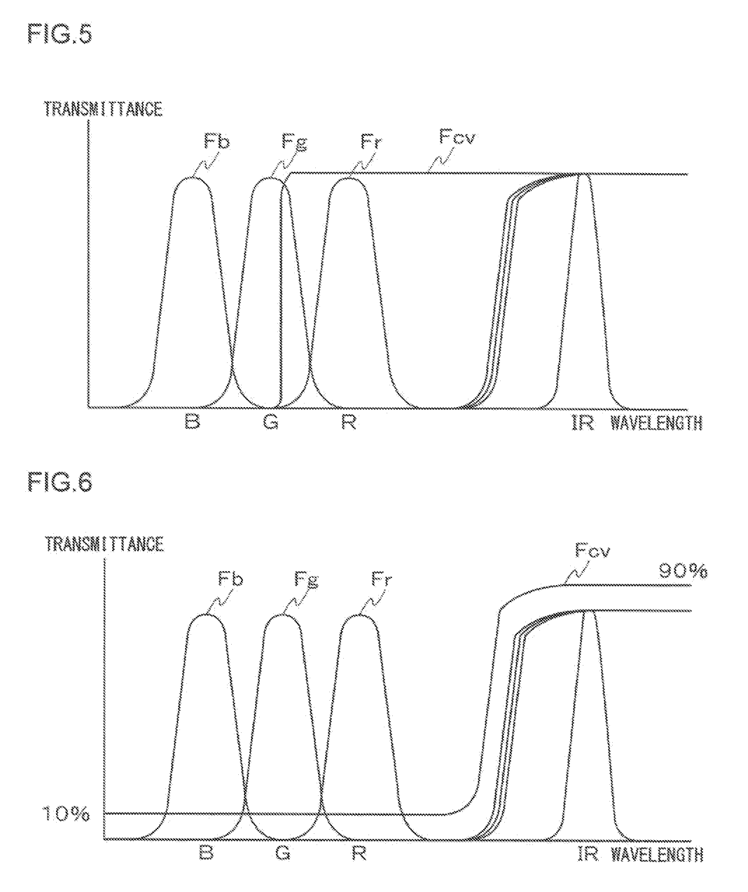

FIGS. 4A and 4B are diagrams showing the roles of the respective image pickup devices in a Bayer arrangement according to the second embodiment of the present invention. FIG. 5 is a graph showing the characteristic Fcv of the visible light cut filter 10, the characteristic Fr of the red transmission filter, the characteristic Fg of the green transmission filter, and the characteristic Fb of the blue transmission filter of the second embodiment. As shown in FIG. 5, the visible light cut filter 10 has the cutoff wavelength in a green wavelength region.

Therefore, for the setting of the projection type image display apparatus 200 and for the calibration of the pointing device 400, the red image pickup device and the green image pickup devices are used as shown in FIG. 4A. This is because the red image pickup device and the green image pickup devices can detect the red component and green components of the visible light components, respectively.

On the other hand, for the pointing during normal projection, the blue image pickup device is used as shown in FIG. 4B. The red transmission filter, the green transmission filter, and the blue transmission filter transmit near-infrared light and also the infrared components of light emitted by the pointing device 400. Yet, by not using the red image pickup device and the green image pickup device which also receive the other visible light (red component and green component herein), the infrared ray illumination by the pointing device 400 can be recognized with accuracy.

According to the second embodiment as described above, the cutoff wavelength of the visible cut filter is set at a shorter-wavelength side. Also, the red transmission filter, the green transmission filter, and the blue transmission filter are each configured by a band-pass filter. Hence, the roles of the respective image pickup devices can be varied. More specifically, in the first embodiment, the resolution is low for the setting of the projector and for the calibration of the pointing device, whereas the resolution is high for the pointing during normal projection. In contrast, in the second embodiment, the resolution is high for the setting of the projector and for the calibration of the pointing device, whereas the resolution is low for the pointing during normal projection.

### Third Embodiment

A third embodiment will now be described. The third embodiment is an example where the visible light cut filter 10 is set to allow a low transmittance without being cut in the visible light region. The structures and operations of an image pickup apparatus 100 and a projection type image display apparatus 200 according to the third embodiment are basically the same as those of the first embodiment and therefore the description thereof is omitted here.

FIG. 6 is a graph showing the characteristic Fcv of the visible light cut filter 10, the characteristic Fr of the red transmission filter, the characteristic Fg of the green transmission filter, and the characteristic Fb of the blue transmission filter of the third embodiment. As shown in FIG. 6, the visible light cut filter 10 is set such that the transmittance of visible light wavelength region (10% in FIG. 6) is set to a value which is greater than zero and which is less than the transmittance of infrared wavelength region (90% in FIG. 6). The transmittance of visible light region may be set to a value based on the designer's experiments and simulation runs.

Since the transmittance of visible light region of the visible light cut filter 10 is low for the setting of the projection type image display apparatus 200 and for the calibration of the pointing device 400, the control unit 60 sets the exposure time of the image pickup devices 30 to a longer duration or amplifies the image values. For example, where the transmittance is 10%, the exposure time is set to as long as ten times. Since the test pattern image projected onto the projection plane 300 is a still image, no problems arises even if the exposure time is set longer.

The transmittance of near-infrared region of the visible light cut filter 10 is high. For the pointing during normal projection, a projected image by the projection type image display apparatus 200 (namely, the wavelength of visible light) is dimmed by the visible light cut filter 10. Thus, the image analysis unit 61 can easily separate the pointing image cast by the infrared rays.

According to the third embodiment as described above, the exposure time required for the pointing during normal projection is short. Thus, the following (tracking) capability to the pointing image that moves fast is high.

The present invention has been described based on the first to the third embodiments. These embodiments are intended to be illustrative only, and it is understood by those skilled in the art that various modifications to constituting elements and processes as well as arbitrary combinations thereof could be developed and that such modifications and combinations are also within the scope of the present invention.

The transmittances of infrared wavelength regions in the red image pickup device, the green image pickup device and the blue image pickup device are approximately equal to each other. The image analysis unit 61 references the pixel values of adjacent red image pickup devices, green image pickup devices and blue image pickup devices and determines the coordinates, where these pixel values thereof are aligned within a certain range, to be bright points by the infrared light emitted from the pointing device 400. The bright points due to the extraneous lights (visible light) not cast by the pointing device 400 differs in the pixel values from the adjacent red pickup image devices, the green image pickup devices and the blue image pickup devices. If it is determined that the bright points are produced by the infrared rays emitted from the pointing device 400, all pixel values of the red image pickup device, the green image pickup device and the blue image pickup device can be utilized for the pointing.

### Fourth Embodiment

In the above-described first to third embodiments, descriptions have been given of a system where the image pickup apparatus 100 is used to both capture a pattern image in start-up setting of the projection type image display apparatus 200 and capture a pointing image projected onto the projection plane 300 by the pointing device 400 emitting infrared rays. Also, a description has been given of an example where the calibration is realized by using the pointing device 400 capable of emitting visible light in setting the projection type image display apparatus 200. It is assumed in the above-described first to third embodiments, however, that a single pointing device 400 for emitting infrared rays is used during normal projection.

In the following embodiments, a description will be given of examples where a plurality of pointing devices are used simultaneously during normal projection. Assume in the fourth embodiment that two kinds of pointing devices, which are (1) a first pointing device emitting red light (e.g., a laser-pointer type electronic pen emitting red light) and (2) a second pointing device emitting infrared rays (e.g., an electronic pen using an infrared LED). For example, assumed is a situation where a teacher and a student or a presenter and a questioner simultaneously draw symbols, characters and the like on the projection plane 300.

The image pickup apparatus 100 according to the fourth embodiment is the same as the image pickup apparatus 100 according to the first embodiment. Thus, as shown in FIG. 3, the image pickup apparatus 100 according to the fourth embodiment uses a visible light cut filter 10 that cuts the green component, the blue component, and part of a shorter-wavelength side of the red component and transmits part of a longer-wavelength side of the red component and the infrared light component.

Comparing the projection type image display apparatus 200 according to the fourth embodiment with the projection type image display apparatus 200 according to the first embodiment, the image analysis unit 61 in the control unit 60 differs. The image analysis unit 61 according to the fourth embodiment indentifies first pointing coordinates specified by the output signal of the red image pickup device, as a pointing image projected onto the projection plane 300 by the first pointing device emitting red light. Also, the image analysis unit 61 according to the fourth embodiment indentifies second pointing coordinates specified by at least one of the output signals of the green image pickup device and the blue image pickup device, as a pointing image projected onto the projection plane 300 by the second pointing device emitting infrared rays.

If the first pointing coordinates and the second pointing coordinates practically agree with each other, the image analysis unit 61 will determine the pointing image projected on the pointing coordinates to be a pointing image projected by the second pointing device.

Here, the case where the first pointing coordinates and the second pointing coordinates agree with each other corresponds to the case where both the first pointing coordinates and the second pointing coordinates are detected and also the both pointing coordinates are two kinds of pixels, respectively, configured in the same Bayer arrangement. Also, that the first pointing coordinates and the second pointing coordinates practically agree with each other means the case where both the first pointing coordinates and the second pointing coordinates are detected and also the first pointing coordinates and the second pointing coordinates are related to each other in such a manner that the both pointing coordinates are adjacent pixels configured in the adjacent Bayer arrangements. The range within which the pixels are regarded adjacent to each other may be adjusted optionally by the designer.

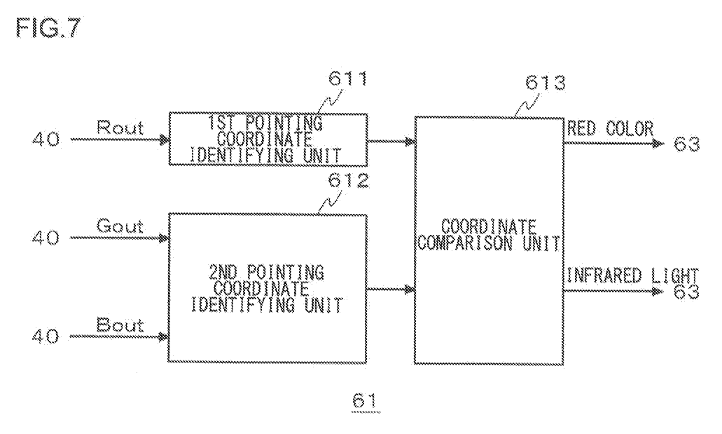

FIG. 7 is a diagram showing an exemplary structure of the image analysis unit 61 according to the fourth embodiment. The image analysis unit 61 includes a first pointing coordinate identifying unit 611, a second pointing coordinate identifying unit 612, and a coordinate comparison unit 613. An output signal Rout of the red image pickup device is inputted to the first pointing coordinate identifying unit 611 via the signal processing circuit 40. An output signal Gout of the green image pickup device and an output signal Bout of the blue image pickup device are inputted to the second pointing coordinate identifying unit 612 via the signal processing circuit 40.

The signal processing circuit 40 performs such processings as A/D conversion and noise removal. It is to be appreciated that the fourth embodiment does not involve conversion from RGB format to YUV format.

The first pointing coordinate identifying unit 611 compares the output signals Rout of the red image pickup device of each pixel against a first preset value. If a pixel that has outputted a signal exceeding the first preset value is detected, the first pointing coordinate identifying unit 611 will convert the address of said pixel into a coordinate system and then output the coordinates to the coordinate comparison unit 613. The first preset value is a value used to detect the reflected light caused by the irradiation light of the first pointing device, and is set to a value by which the reflected light caused by the light emitted from the first pointing device, and the reflected light from the image projected onto the projection plane 300, environmental light, and so on can be distinguished from each other.

The second pointing coordinate identifying unit 612 compares the output signals Gout of the green image pickup device of each pixel against a second preset value. If a pixel that has outputted a signal exceeding the second preset value is detected in the output signals Gout of the green image pickup device, the second pointing coordinate identifying unit 612 will convert the address of said pixel into a coordinate system and then output the coordinates to the coordinate comparison unit 613. Similarly, the second pointing coordinate identifying unit 612 compares the output signals Bout of the blue image pickup device of each pixel against a third preset value. If a pixel that has outputted a signal exceeding the third preset value is detected in the output signals Bout of the blue image pickup device, the second pointing coordinate identifying unit 612 will convert the address of said pixel into a coordinate system and then output the coordinates to the coordinate comparison unit 613.

The second preset value and the third preset value are also set under the same design concept as the first preset value. Each preset value is actually determined based on the intensities of light emitted from the first pointing device and the second pointing device, the sensitivity of each pickup device where the red transmission filter, the green transmission filter and the blue transmission filter are installed, and so forth.

The configuration may be such that the output signal Gout of the green image pickup device of each pixel added with the output signal Gout of the green image pickup device corresponding thereto are inputted to the second pointing coordinate identifying unit 612. In this case, the added signal and a fourth preset value are compared with each other. The fourth preset value is also set under the same design concept as the first preset value.

The coordinate comparison unit 613 outputs the coordinates detected by the first pointing coordinate identifying unit 611, to the synthesis unit 63 as the coordinates that indicate the pointing image by the first pointing device emitting the red light. The synthesis unit 63 makes settings in the image signal setting unit 65 such that data of a predetermined color (e.g., red) is rendered at the first pointing coordinates.

The coordinate comparison unit 613 outputs the coordinates detected by the second pointing coordinate identifying unit 612, to the synthesis unit 63 as the coordinates that indicate the pointing image by the second pointing device emitting the infrared rays. The synthesis unit 63 makes settings in the image signal setting unit 65 such that data of a predetermined color (e.g., black) is rendered at the second pointing coordinates.

If the first pointing coordinates and the second pointing coordinates detected by the first pointing coordinate identifying unit 611 and the second pointing coordinate identifying unit 612, respectively, practically agree with each other, the coordinate comparison unit 613 will output the coordinates to the synthesis unit 63 as the coordinates indicating the pointing image by the second pointing device emitting the infrared rays but not as the coordinates indicating the pointing image by the first pointing device emitting the red light. The synthesis unit 63 makes settings in the image signal setting unit 65 such that data of a predetermined color (e.g., black) is rendered at the coordinates.

According to the fourth embodiment as described above, during normal projection two pointing devices can be simultaneously used with accuracy in addition to the advantageous effects achieved by the projection image display apparatus 200 according to the first embodiment. In particular, where two pointing images by the two pointing devices agree with each other or are located close to each other on the projection plane, which pointing device makes the pointing image can be determined with accuracy.

### Fifth Embodiment

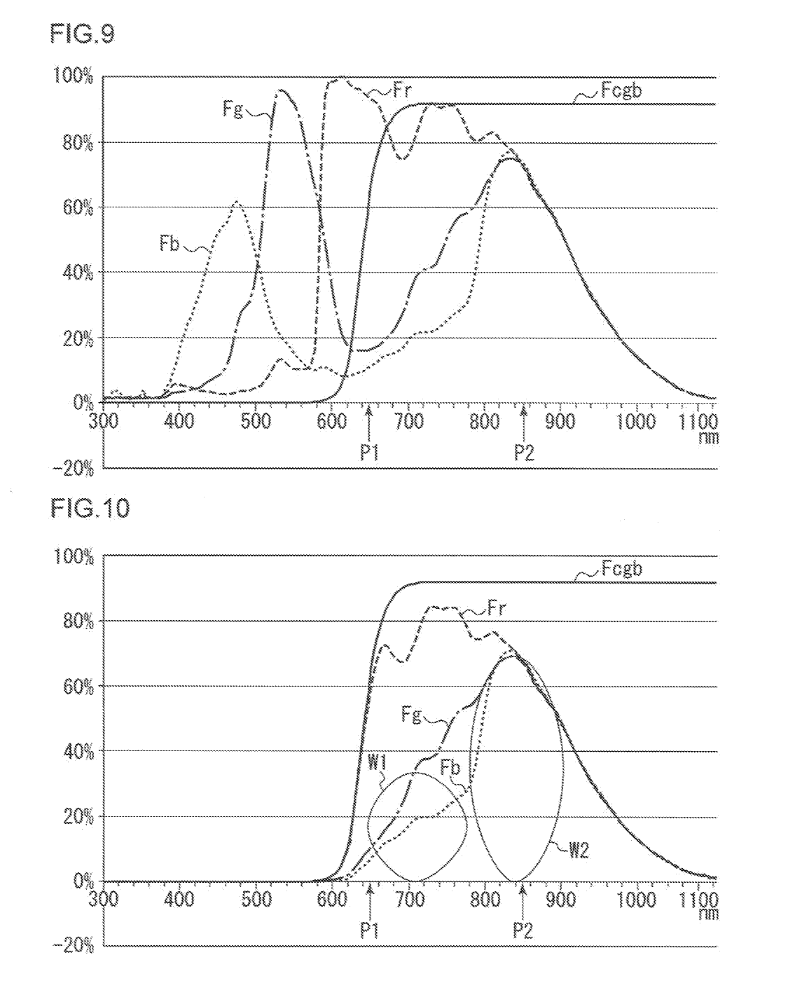

In the first to fourth embodiments thus far explained, descriptions have been given of examples which use the RGB primary color filter having ideal spectral sensitivity characteristics as shown in FIG. 3, FIG. 5, and FIG. 6. The RGB primary color filter having such spectral sensitivity characteristics is not a mass-produced product and is therefore expensive. In the following embodiments to be explained below, a description will be given of an example in which a low-cost mass-produced RGB primary color filter (e.g., an RGB primary color filter having spectral sensitivity characteristics such as shown in FIG. 9) is used. Note also that the fifth embodiment, as with the fourth embodiment, is based on the simultaneous. use of the first pointing device and the second pointing device in the ordinary use of the projection type image display apparatus 200.

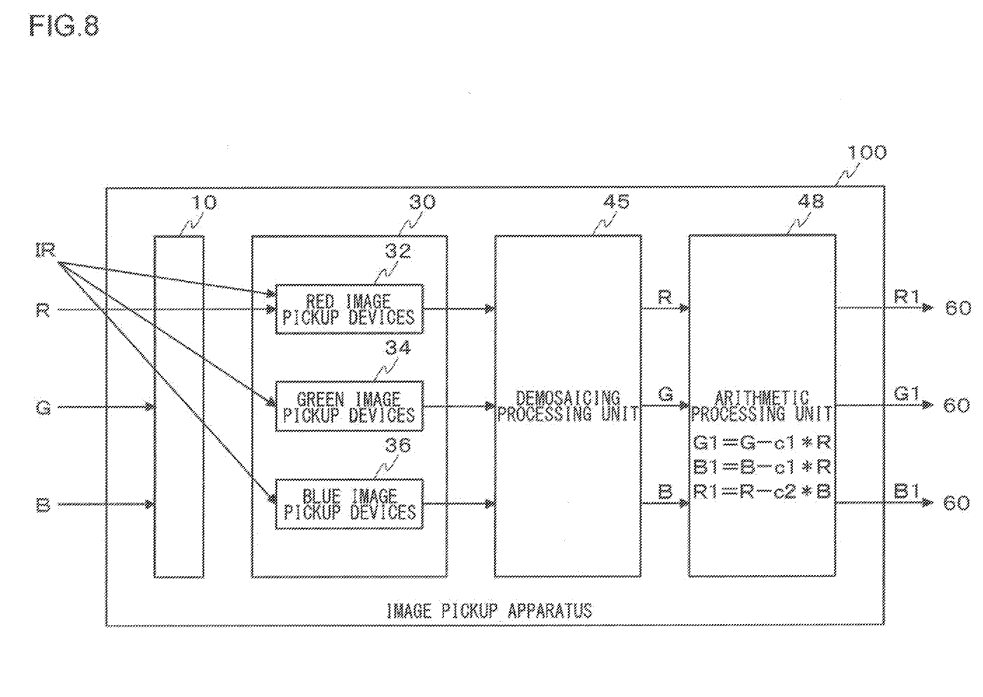

FIG. 8 is a diagram showing a structure of an image pickup apparatus 100 according to the fifth embodiment. Note that, unlike FIG. 1, FIG. 8 omits the lens 20 and the signal processing circuit 40 in its illustration. The not-shown signal processing circuit, which is provided between the image pickup devices 30 and a demosaicing processing unit 45, performs such processings as A/D conversion and noise removal. It is to be appreciated that the fifth embodiment does not involve conversion from RGB format to YUV format.

Similar to the fourth embodiment, the visible light cut filter 10 cuts the green component, the blue component, and part of the shorter-wavelength side of the red component and transmits part of the longer-wavelength side of the red component and the infrared light component. Hereinbelow in the fifth embodiment, this visible light cut filter 10 will be referred to as the GB cut filter.

The demosaicing processing unit 45 classifies the signals outputted from the image pickup devices 30 into output signals R from the red image pickup devices 32, output signals G from the green image pickup devices 34, and output signals B from the blue image pickup devices 36 and outputs the classified signals to an arithmetic processing unit 48.

The arithmetic processing unit 48 corrects the output signals R, G, and B from the red image pickup devices 32, the green image pickup devices 34, and the blue image pickup devices 36, respectively, in order to lower, in a pseudo manner, the sensitivity in the near-infrared wavelength region of the red image pickup devices 32 and the sensitivity in the red wavelength region of the green image pickup devices 34 and the blue image pickup devices 36. The arithmetic processing unit 48 may perform the computation by the use of such hardware as a multiplier or an adder or through software processing by a processor.

As indicated in Equation (1) below, the arithmetic processing unit 48 obtains an output signal G1 after the correction of the green image pickup device 34 by subtracting a signal, which is the output signal R of the red image pickup device 32 multiplied by a first coefficient cl (positive value), from the output signal G of the green image pickup device 34. Also, as indicated in Equation (2) below, the arithmetic processing unit 48 obtains an output signal B1 after the correction of the blue image pickup device 36 by subtracting a signal, which is the output signal R of the red image pickup device 32 multiplied by the first coefficient c1 (positive value), from the output signal B of the blue image pickup device 36. Also, as indicated in Equation (3) below, the arithmetic processing unit 48 obtains an output signal R1 after the correction of the red image pickup device 32 by subtracting a signal, which is the output signal B of the blue image pickup device 36 or the output signal G of the green image pickup device 34 multiplied by a second coefficient c2 (positive value), from the output signal R of the red image pickup device 32. The arithmetic processing unit 48 outputs the respective output signals R1, G1, and B1 after the correction to the control unit 60.

G1=G−c1*R Equation (1)

B1=B−c1*R Equation (2)

R1=R−c2*B Equation (3)

The image analysis unit 61 according to the fifth embodiment identifies the pointing coordinates specified by the output signal R1 after the correction of the red image pickup device 32 as the pointing coordinates projected onto the projection plane 300 by the first pointing device emitting red light. Also, the image analysis unit 61 according to the fifth embodiment identifies the pointing coordinates specified by at least one of the output signals G1 and B1 of the green image pickup device 34 and the blue image pickup device 36 as the pointing coordinates projected onto the projection plane 300 by the second pointing device emitting infrared rays.

The synthesis unit 63 makes settings in the image signal setting unit 65 such that data of mutually different colors are rendered at the pointing coordinates specified by the output signal R1 after the correction of the red image pickup device 32 and the pointing coordinates specified by at least one of the output signals G1 and B1 of the green image pickup device 34 and the blue image pickup device 36.

FIG. 9 is a graph showing the characteristic Fcgb of the GB cut filter as well as the characteristic Fr of the red transmission filter, the characteristic Fg of the green transmission filter, and the characteristic Fb of the blue transmission filter before the installation of the GB cut filter, according to the fifth embodiment. The RGB primary color filter of FIG. 9 is one of less expensive mass-produced products and has the spectral sensitivity characteristics lower than those of the RGB primary color filter of FIG. 3. The example to be described below is based on the wavelength of the red light emitted by the first pointing device being about 645 nm (see P1 in FIG. 9) and the wavelength of the infrared rays emitted by the second pointing device being about 850 nm (see P2 in FIG. 9).

In the fifth embodiment as described above, the red light from the first pointing device is recognized by the red image pickup device 32, and the infrared rays from the second pointing device are recognized by the green image pickup device 34 or the blue image pickup device 36. In this case, it is preferable that the green image pickup device 34 and the blue image pickup device 36 have sensitivity only in a neighborhood of the wavelengths of the infrared rays emitted by the second pointing device. On the other hand, it is preferable that the red image pickup device 32 has sensitivity only in the neighborhood of the wavelengths of the red light emitted by the first pointing device.

FIG. 10 is a graph showing the characteristic Fcgb of the GB cut filter as well as the characteristic Fr of the red transmission filter, the characteristic Fg of the green transmission filter, and the characteristic Fb of the blue transmission filter after the installation of the GB cut filter, according to the fifth embodiment. The green component and the blue component of light are cut by the GB cut filter before the light enters the RGB primary color filter.

In FIG. 10, the green transmission filter and the blue transmission filter have a transmittance of about 20% in the red wavelength region (about 620 to 750 nm) (see W1 in FIG. 9). In other words, the green image pickup device 34 and the blue image pickup device 36 also have sensitivity in the visible light wavelength region, which is of shorter wavelengths than the near-infrared wavelength region. This sensitivity, however, is one not required in the recognition processing of the fifth embodiment.

Also, the red transmission filter has a transmittance of over 60% in the wavelength region of about 780 to 900 nm (see W2 in FIG. 9) in the near-infrared wavelength region. In other words, the red image pickup device 32 has sensitivity in this wavelength region. This sensitivity, however, is one not required in the recognition processing of the fifth embodiment.

For the image pickup apparatus 100 having spectral sensitivity characteristics as shown in FIG. 10, the accuracy of recognizing the pointing coordinates is lower than that of the image pickup apparatus 100 having spectral sensitivity characteristics as shown in FIG. 3. This is because of the effects of the projection light (visible light) itself from the projection type image display apparatus 200, the reflected light from the projection plane to which the projection light is projected, the reflected light of the projection light hitting the pointing device or the person holding it, and other environmental lights. Furthermore, the discrimination accuracy may get lower if a plurality of pointing devices are used simultaneously.

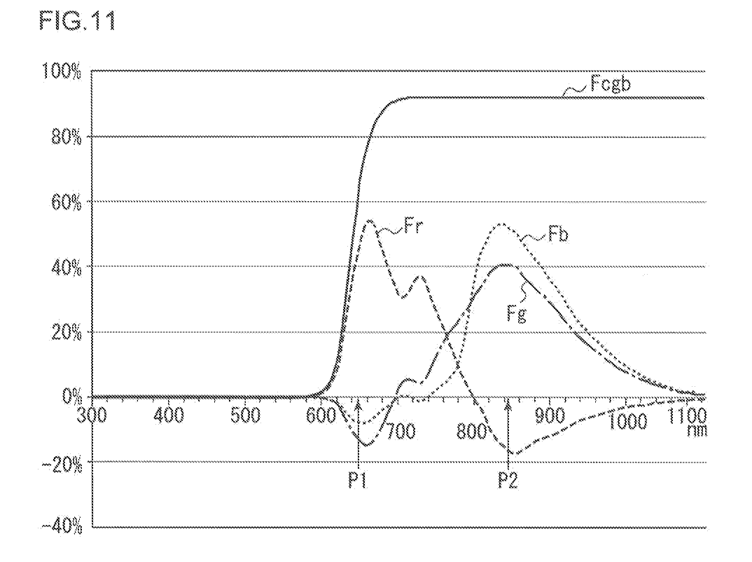

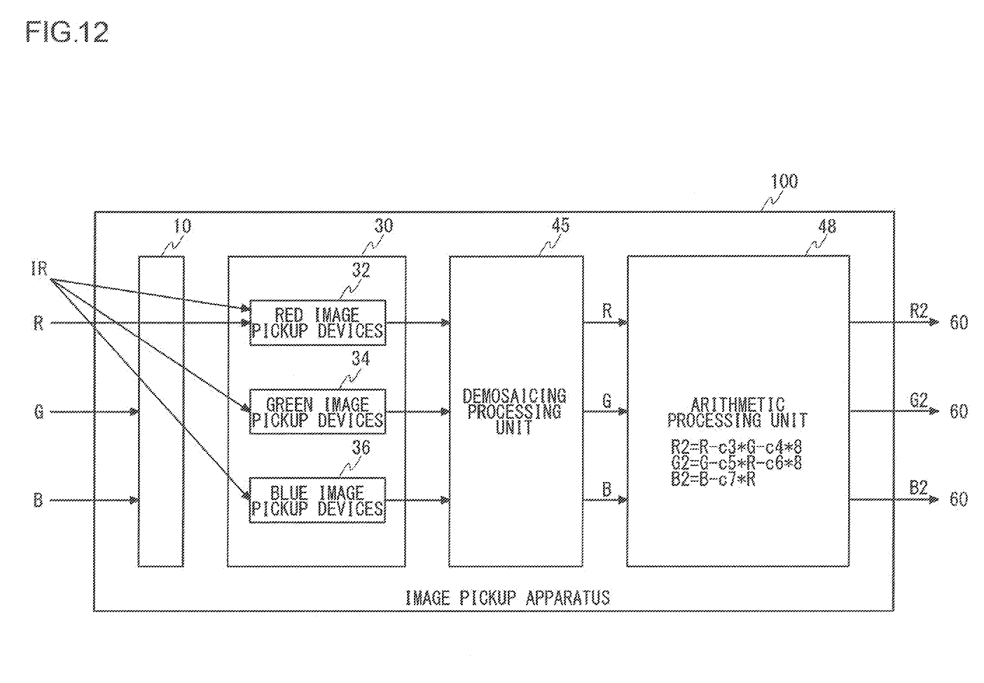

FIG. 11 is a diagram showing the characteristic Fcgb of the GB cut filter as well as the characteristic Fr of the red transmission filter, the characteristic Fg of the green transmission filter, and the characteristic Fb of the blue transmission filter after the installation of the GB cut filter and the addition of the pseudo correction, according to the fifth embodiment. As already mentioned, the arithmetic processing unit 48 subtracts a fixed proportion of the output signal R of the red image pickup device 32 from the output signal G of the green image pickup device 34 and the output signal B of the blue image pickup device 36. Also, the arithmetic processing unit 48 subtracts a fixed proportion of the output signal B of the blue image pickup device 36 or the output signal G of the blue image pickup device 34 from the output signal R of the red image pickup device 32.

In this manner, a conversion into spectral sensitivity characteristics as shown in FIG. 11 is accomplished. In FIG. 11, the green transmission filter and the blue transmission filter have a transmittance of 0% or below in the red wavelength region (about 620 to 750 nm) (see W1 in FIG. 10). In other words, the green image pickup device 34 and the blue image pickup device 36 have zero sensitivity in this wavelength region.

Also, the red transmission filter has a transmittance of 10% or below in the wavelength region of about 780 to 900 nm in the near-infrared wavelength region (see W2 in FIG. 10). In other words, the red transmission filter has little sensitivity in this wavelength region.

Each of the values to be subtracted from the output signal G of the green image pickup device 34, the output signal B of the blue image pickup device 36, and the output signal R of the red image pickup device 32, respectively, is set to a value calculated by the designer based on the spectral sensitivity characteristics of the image pickup devices 30 and the characteristic Fcgb of the GB cut filter.

The first coefficient c1 used to determine the values to be subtracted from the output signal G of the green image pickup device 34 and the output signal B of the blue image pickup device 36, respectively, is determined as follows, for instance. That is, the first coefficient c1 is set to a value such that the sensitivity in a wavelength region between the half-wavelength of the GB cut filter (i.e., the wavelength at which the transmittance becomes 50%) and a wavelength on the boundary of a lower-wavelength side of the near-infrared wavelength region becomes lower in a pseudo manner. Ideally, the value is preferably set such that the sensitivity of the green image pickup device 34 and the blue image pickup device 36 in said wavelength region is practically zero.

The second coefficient c2 used to determine the value to be subtracted from the output signal R of the red image pickup device 32 is set such that the sensitivity in the near-infrared wavelength region is lowered in a pseudo manner. Ideally, the value is preferably set such that the sensitivity of the red image pickup device 32 in the near-infrared wavelength region is practically zero. In the examples of FIG. 9 to FIG. 11, the first coefficient cl is set to 0.4 and the second coefficient to 0.9. Substituting these values into the above Equation (1) to Equation (3), the following Equation (4) to Equation (6) result.

G1=G−(0.4*R) Equation (4)

B1=B−(0.4*R) Equation (5)

R1=R−(0.9*B) Equation (6)

According to the fifth embodiment as described above, the arithmetic processing unit 48, which is provided in the image pickup apparatus 100, corrects the output signal of each image pickup device and therefore the robustness for the pointing is improved. Hence, the same advantageous effects as those of the fourth embodiment can be achieved even though the RGB primary color filter having low spectral sensitivity characteristics is used.

### Sixth Embodiment

FIG. 12 is a diagram showing a structure of an image pickup apparatus 100 according to a sixth embodiment. Note that, unlike FIG. 1, FIG. 12 omits the lens 20 and the signal processing circuit 40 in its illustration. The not-shown signal processing circuit, which is provided between the image pickup devices 30 and the demosaicing processing unit 45, performs such processings as A/D conversion and noise removal. It is to be appreciated that the sixth embodiment does not involve conversion from RGB format to YUV format.

The visible light cut filter 10 transmits the infrared component, the red component and the green component and blocks the blue component. Hereinbelow in the sixth embodiment, this visible light cut filter 10 will be referred to as the B cut filter.

The demosaicing processing unit 45 classifies the signals outputted from the image pickup devices 30 into the output signals R from the red image pickup devices 32, the output signals G from the green image pickup devices 34, and the output signals B from the blue image pickup devices 36 and outputs the classified signals to the arithmetic processing unit 48.

The arithmetic processing unit 48 generates three kinds of signals, which are a red component signal R2, a green component signal G2, and an near-infrared component signal B2 by subjecting the output signals R, G, and B from the red image pickup devices 32, the green image pickup devices 34, and the blue image pickup devices 36, respectively, to mutually different predetermined arithmetic operations.

As indicated in Equation (7) below, the arithmetic processing unit 48 generates the red component signal R2, which has lowered in a pseudo manner the sensitivity in the near-infrared wavelength region, by subtracting (i) a signal which is the output signal G of the green image pickup device 34 multiplied by a third coefficient c3 (positive value) and (ii) a signal which is the output signal B of the blue image pickup device 36 multiplied by a fourth coefficient c4 (positive value) from the output signal R of the red image pickup device 32. Also, as indicated in Equation (8) below, the arithmetic processing unit 48 generates the green component signal G2, which has lowered in a pseudo manner the sensitivity in the near-infrared wavelength region, by subtracting (iii) a signal which is the output signal R of the red image pickup device 32 multiplied by a fifth coefficient c5 (positive value) and (iv) a signal which is the output signal B of the blue image pickup device 36 multiplied by a sixth coefficient c5 (positive value) from the output signal G of the green image pickup device 34. Also, as indicated in Equation (9) below, the arithmetic processing unit 48 generates the near-infrared component signal B2, which has lowered in a pseudo manner the sensitivity in the visible light region, by subtracting a signal, which is the output signal R of the red image pickup device 32 multiplied by a seventh coefficient c7 (positive value), from the output signal B of the blue image pickup device 36. The arithmetic processing unit 48 outputs the generated red component signal R2, green component signal G2 and near-infrared component signal B2 to the control unit 60.

R2=R−c3*G−c4*B Equation (7)

G2=G−c5*R−c6*B Equation (8)

B2=B−c7*R Equation (9)

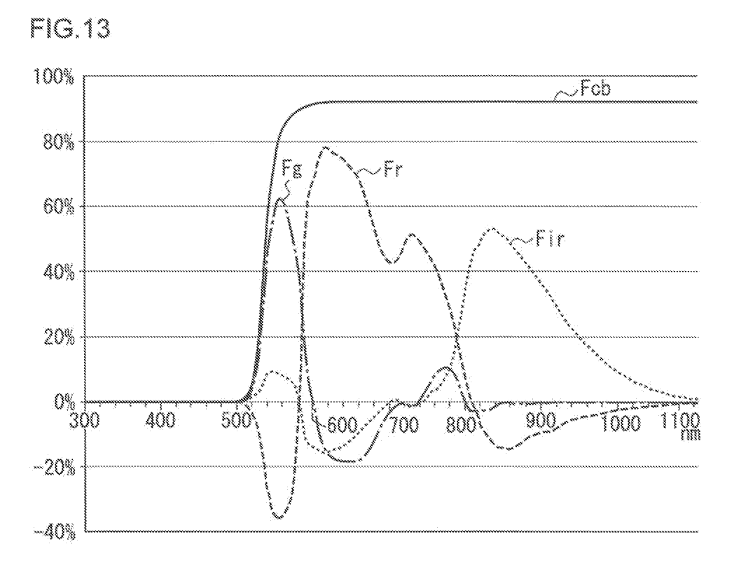

FIG. 13 is a graph showing the characteristic Fcb of the B cut filter as well as the characteristic Fr of the red transmission filter, the characteristic Fg of the green transmission filter, and the characteristic Fir of the blue transmission filter after the installation of the B cut filter, according to the sixth embodiment. In the sixth embodiment, the blue transmission filter cuts the visible light component and converts into a filter having a characteristic of transmitting the infrared component. Thus, the characteristic of the blue transmission filter is denoted by the characteristics Fir in FIG. 13.

The blue component of light incident to the RGB primary color filter is cut by the B cut filter. Note that the characteristic Fr of the red transmission filter, the characteristic Fg of the green transmission filter, and the characteristic Fb of the blue transmission filter before the installation of the B cut filter are the same as those shown in FIG. 9.

As shown in FIG. 13, provision of the B cut filter and the arithmetic processing unit 48 allows the spectral sensitivity characteristics as shown in FIG. 9 to be converted into the spectral sensitivity characteristics where the components are separated into the green component, the red component, and the infrared component almost without being overlapped with each other. In other words, the B cut filter and the arithmetic processing unit 48 are added to a commonly-used image pickup apparatus that uses the RGB primary color filter having low spectral sensitivity characteristics. Thereby, the wavelength region may be shifted to a longer-wavelength side. Thus the image pickup apparatus capable of identifying, with a high degree of accuracy, the three kinds of components which are the green component, the red component, and the infrared component can be realized.

Similar to the fifth embodiment, each of the values of the third coefficient c3 to the seventh coefficient c7 used in the above Equation (7) to Equation (9) is set to a value calculated by the designer based on the spectral sensitivity characteristics of the image pickup devices 30 and the characteristic Fcb of the B cut filter. In the examples of FIG. 9 to FIG. 13, the third coefficient c3 is set to 0.5, the fourth coefficient c4 to 0.7, the fifth coefficient c5 to 0.3, the sixth coefficient c6 to 0.7, and the seventh coefficient to 0.25. Substituting these values into the above Equation (7) to Equation (9), the following Equation (10) to Equation (12) result.

R2=R−0.5*G−0.7*G Equation (10)

G2=G−0.3*R−0.7*B Equation (11)

B2=B−0.25*R Equation (12)

The image analysis unit 61 according to the sixth embodiment identifies the pointing coordinates specified by the red component signal R2 as the pointing coordinates projected onto the projection plane 300 by a pointing device emitting red light. Also, the image analysis unit 61 according to the sixth embodiment identifies the pointing coordinates specified by the green component signal G2 as the pointing coordinates projected onto the projection plane 300 by a pointing device emitting green light. Also, the image analysis unit 61 according to the sixth embodiment identifies the pointing coordinates specified by the infrared component signal B2 as the pointing coordinates projected onto the projection plane 300 by a pointing device emitting infrared rays.

The synthesis unit 63 makes settings in the image signal setting unit 65 such that data of mutually different colors are rendered at the pointing coordinates specified by the red component signal R2, the pointing coordinates specified by the green component signal G2, and the pointing coordinates specified by the near-infrared component signal B2, respectively. In this manner, the three pointing devices can be simultaneously used with accuracy in the sixth embodiment.

Also, according to the image pickup apparatus 100 of the sixth embodiment, the three components, which are the green component, the red component and the infrared component, can be used in start-up setting of the projection type image display apparatus 200. There is available a projection type image display apparatus 200 provided with a wall color correction function for adjusting the projection plane to the white color during projection where the color of wall used as the projection plane is other than the white color is. According the sixth embodiment, the green component, the red component and the infrared component are detected, so that the color of the projection plane can be easily estimated. Then, the color balance is adjusted based on the estimated result and thereby the color of the projection plane can be brought as close as to the white. Also, in the above-described focus adjustment, the two components which are the green component and the red component are used and thereby the adjustment can be made more accurately than when the red component only is used.

According to the sixth embodiment as described above, the B cut filter and the arithmetic processing unit are added to a commonly-used image pickup apparatus that uses the RGB primary color filter having low spectral sensitivity characteristics. As a result, realized is the image pickup apparatus capable of shifting the wavelength region to a longer-wavelength side and identifying, with a high degree of accuracy, the three kinds of components which are the green component, the red component, and the infrared component. Such an image pickup apparatus according to each of the above-described embodiments is not only applicable to the projection type image display apparatus but also applicable to a monitoring camera, where the detection of infrared rays is effective, and other variety of usages.

The description of the present invention given above is based upon illustrative embodiments. These embodiments are intended to be illustrative only and it will be obvious to those skilled in the art that various modifications to constituting elements and processes could be further developed and that such additional modifications are also within the scope of the present invention.

What is claimed is:

1. An image pickup apparatus, comprising:
a visible light cut filter configured to transmit an infrared component and configured to block a visible light component; and
a plurality of image pickup devices configured to receive light transmitted through said visible light cut filter such that a plurality of color components are received separately from each other,
wherein said visible light cut filter allows part of the visible light components to transmit such that the visible light component enters at least one of the plurality of image pickup devices.

2. An image pickup apparatus according to claim 1, wherein the plurality of image pickup devices include a red image pickup device for receiving a red component, a green image pickup device for receiving a green component, and a blue image pickup component for receiving a blue component, and
wherein said visible light cut filter allows at least part of the red component to transmit such that at least the part of the red component enters the red image pickup device.

3. An image pickup apparatus according to claim 2, further comprising an arithmetic processing unit configured to correct output signals from the red image pickup device, the green image pickup device and the blue image pickup device, respectively, to lower, in a pseudo manner, the sensitivity in a near-infrared wavelength region of the red image pickup device and the sensitivity in a red wavelength region of the green image pickup device and the blue image pickup device.

4. An image pickup apparatus according to claim 3, wherein said arithmetic processing unit subtracts a signal, which is obtained when an output signal of the red image pickup device is multiplied by a first coefficient of a positive value, from output signals of the green image pickup device and the blue image pickup device, respectively, and
wherein said arithmetic processing unit subtracts a signal, which is obtained when an output signal of the blue image pickup device or an output signal of the green image pickup device is multiplied by a second coefficient of a positive value, from an output signal of the red image pickup device.

5. An image pickup apparatus according to claim 1, wherein said visible light cut filter is set such that the transmittance of visible light wavelength region is set to a value which is greater than zero and which is less than the transmittance of near-infrared wavelength region.

6. An image pickup apparatus according to claim 1, wherein said visible light cut filter allows an infrared component, a red component and a green component to transmit and blocks a blue component, and
the plurality of image pickup devices include a red image pickup device, a green image pickup device and a blue image pickup device and for receiving light that has passed through said visible light cut filter,
said image pickup apparatus further comprising an arithmetic processing unit configured to generate three kinds of signals which are a red component signal, a green component signal and an infrared component signal, by subjecting output signals of the red image pickup device, the green image pickup device and the blue image pickup device to mutually different predetermined arithmetic operations, respectively.

7. An image pickup apparatus according to claim 6, wherein said arithmetic processing unit generates the red component signal, which has lowered in a pseudo manner the sensitivity in a near-infrared wavelength region, by subtracting (i) a signal which is an output signal of the green image pickup device multiplied by a third coefficient of a positive value and (ii) a signal which is an output signal of the blue image pickup device multiplied by a fourth coefficient of a positive value, from an output signal of the red image pickup device,
wherein said arithmetic processing unit generates the green component signal, which has lowered in a pseudo manner the sensitivity in a near-infrared wavelength region, by subtracting (iii) a signal which is the output signal of the red image pickup device multiplied by a fifth coefficient of a positive value and (iv) a signal which is the output signal of the blue image pickup device multiplied by a sixth coefficient of a positive value, from the output signal of the green image pickup device, and
wherein said arithmetic processing unit generates the near-infrared component signal, which has lowered in a pseudo manner the sensitivity in a visible light region, by subtracting a signal which is the output signal of red image pickup device multiplied by a seventh coefficient of a positive value, from the output signal of the blue image pickup device.

8. A projection type image display apparatus, comprising:
a projection unit configured to project an image onto a projection plane; and
an image pickup apparatus, according to claim 2, configured to pick up an image of the projection plane,
wherein said image pickup apparatus is used to both pick up a pattern image in start-up setting of said projection type image display apparatus and pick up a pointing image projected onto the projection plane by a pointing device emitting infrared rays.

9. A projection type image display apparatus according to claim 8, wherein the pointing device is capable of emitting the infrared rays and visible light, and
wherein said image pickup apparatus is used to pick up an image in a calibration processing for the pointing device emitting the visible light.

10. A projection type image display apparatus according to claim 8, further comprising an image analysis unit configured to identify first pointing coordinates specified by an output signal of the red image pickup device as a pointing image projected onto the projection plane by a first pointing device emitting red light, and configured to identify second pointing coordinates specified by at least one of output signals of the green image pickup device and the blue image pickup device, as a pointing image projected onto the projection plane by a second pointing device emitting infrared rays.

11. A projection type image display apparatus according to claim 10, wherein when the first pointing coordinates and the second pointing coordinates practically agree with each other, the pointing image projected on the pointing coordinates is determined to be the pointing image projected by the second pointing device.

12. A projection type image display apparatus, comprising:
a projection unit configured to project an image onto a projection plane;
an image pickup apparatus, according to claim 3, configured to pick up an image of said projection unit; and
an image analysis unit configured to indentify pointing coordinates specified by the output signal of the red image pickup device after correction, as pointing coordinates projected onto the projection plane by a pointing device emitting red light, and configured to identify pointing coordinates specified by at least one of the output signals of the green image pickup device and the blue image pickup device after correction, as pointing coordinates projected onto the projection plane by a pointing device emitting infrared rays.
